(19) United States
(12) Patent Application Publication
(10) Pub. No.: US 2014/0083542 A1
(43) Pub. Date: Mar. 27, 2014

(54) Quick coupling

(71) Applicant: Chin Chuan Chen, Taichung (TW)

(72) Inventor: Chin Chuan Chen, Taichung (TW)

(21) Appl. No.: 13/624,972

(22) Filed: Sep. 24, 2012

(51) Int. Cl. F16L 37/05

(52) U.S. Cl. 137/798

(57) ABSTRACT

A quick coupling includes a male element including a coupling member at one end and an annular groove adjacent to the coupling member; a valve member including a passageway, a spring activated channel member not communicating the passageway before the male element and the valve member are joined; and a female element including a passage member releasably secured to the valve member with the channel member partially disposed therein, the passage member including equally spaced openings each with a fastening member moveably disposed therein; and a spring activated sleeve slidably put on both the passage member and the valve member. The fastening members partially enter the groove and a communication is established from the male element to the passageway via the channel member after inserting the coupling member into the passage member to join the male element and the valve member in a locked position.

### BACKGROUND OF THE INVENTION

1. Field of the Invention

The invention relates to quick coupling for joining two fluid lines and more particularly to such a quick coupling with improved characteristics.

2. Description of Related Art

A hollow, cylindrical part 10 of a female element of a conventional quick coupling is shown in FIGS. 14 and 15 and comprises four equally spaced openings 11 on a surface, and four oval fastening members 12 fitted in the complementarily shaped openings 11 respectively. The fastening member 12 comprises a left part 121, a right part 122, and an intermediate part 123 interconnecting the left and right parts 121, 122.

However, the fastening of the fastening members 12 in the openings 11 is unreliable after a short time of use due to wearing. Thus, the need for improvement still exists.

### SUMMARY OF THE INVENTION

It is therefore one object of the invention to provide a quick coupling comprising a hollow male element having both ends open, the male element comprising a coupling member at one end and an annular groove adjacent to the coupling member; a valve member comprising a passageway, a spring activated channel member being not in communication with the passageway before the male element and the valve member are joined; and a female element comprising a passage member having both ends open, the passage member being releasably secured to the valve member with the channel member partially disposed therein, the passage member including a plurality of equally spaced openings, a plurality sets of two opposite inner stop members wherein the opposite inner stop members of each set are formed at both sides of each opening respectively, and a plurality of fastening members moveably disposed in the openings; and a spring activated sleeve slidably put on both the passage member and the valve member; wherein the fastening member are partially disposed in the opening before the male element and the valve member are joined; and wherein the fastening members partially enter the groove and a communication is established from the male element to the passageway via the channel member after inserting the coupling member into the passage member to join the male element and the valve member in a locked position.

The above and other objects, features and advantages of the invention will become apparent from the following detailed description taken with the accompanying drawings.

### BRIEF DESCRIPTION OF THE DRAWINGS

FIG. 1 is an exploded view in part section showing a quick coupling according to he invention before its two parts are joined, a passage member of a female element of the quick coupling implemented as a first preferred embodiment;

FIG. 2A is a side elevation of the fastening member which is implemented as a first configuration;

FIG. 2B is a front view of the fastening member of FIG. 2A;

FIG. 3 is an exploded view showing the passage member of the female element of FIG. 1 before the fastening members are held in place in the openings;

FIG. 4 is a longitudinal sectional view showing the female element and the male element in their assembled state;

FIG. 5 is a view similar to FIG. 4 with the female element removed;

FIG. 6 is a sectional view taken along line 6-6 of FIG. 4;

FIG. 7 is a sectional view taken along line 7-7 of FIG. 5;

FIG. 8 is a perspective view of a portion of a passage member of a female element of a quick coupling, the passage member being implemented as a second preferred embodiment;

FIG. 9 is a perspective view of a portion of a passage member of a female element of a quick coupling, the passage member being implemented as a third preferred embodiment;

FIG. 10A is a side elevation of the fastening member which is implemented as a second configuration;

FIG. 10B is a front view of the fastening member of FIG. 10A;

FIG. 11 is a cross-sectional view showing four fastening members of FIG. 10A fitted in the openings of FIG. 8 in its fastened state;

FIG. 12 is a view similar to FIG. 11 showing the fastening members in the openings of FIG. 9 in its unfastened state;

FIG. 13 is a view similar to FIG. 11 showing three fastening members of FIG. 10A fitted in the openings of FIG. 9 in its fastened state;

FIG. 14 is a side elevation a fastening member to be secured to a part of a female element of conventional quick coupling; and

FIG. 15 is an exploded view of a part of a female element of a conventional quick coupling showing the fastening members to be fitted in openings of the part of the female element.

### DETAILED DESCRIPTION OF THE INVENTION

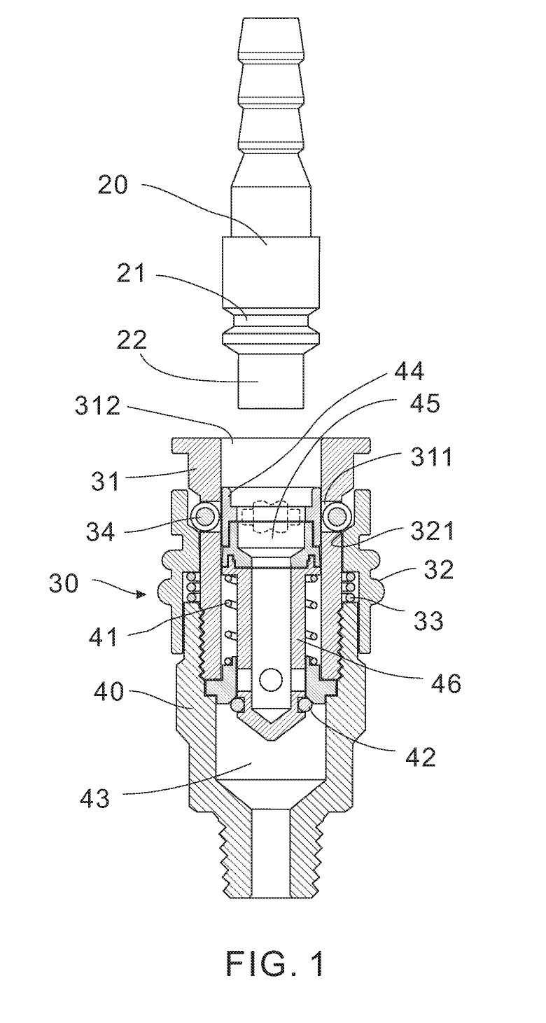

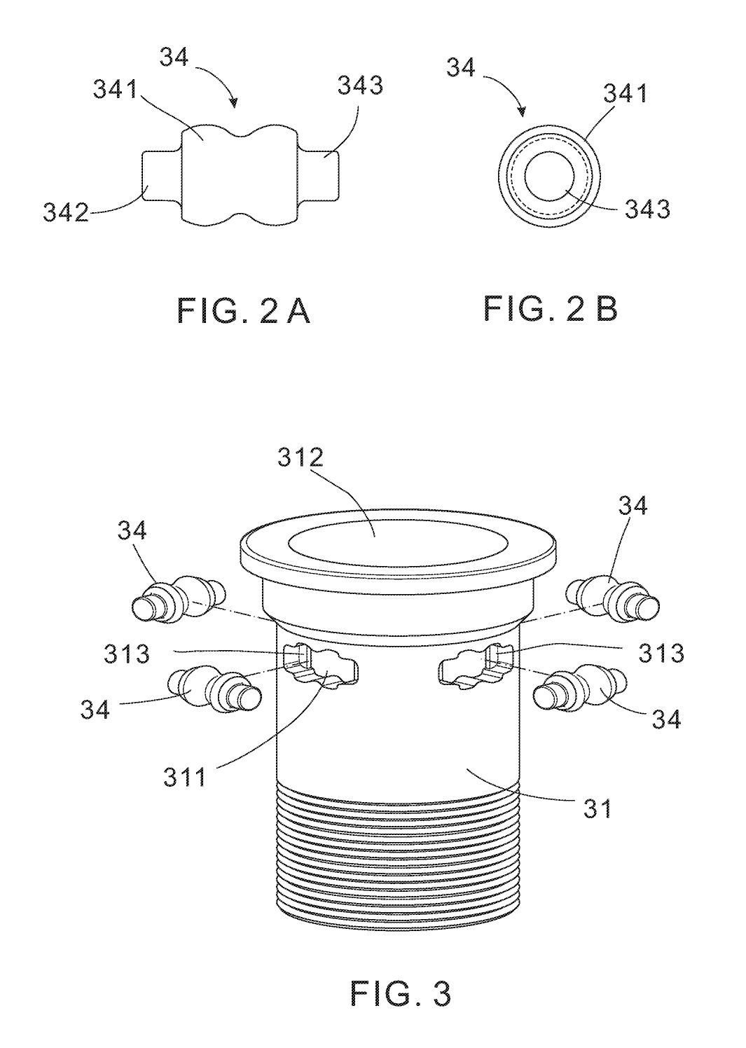

Referring to FIGS. 1 to 7, a quick coupling in accordance with the invention comprises the following components as discussed in detail below.

A male element 20 is hollow and has both ends open. The male element 20 comprises a coupling member 22 at one end and an annular groove 21 adjacent to the coupling member 22. The other end of the male element 20 communicates one fluid line (not shown).

A valve member 40 comprises a passageway 43 having one end communicating the other fluid line (not shown), a channel member 46, a sealing ring 42 for blocking a flow path from the passageway 43 to the channel member 46 (or vice versa) or not as detailed later, a torsion spring 41 put on the channel member 46, a seat 45 on the other end of the channel member 46 distal the passageway 43, and a cylindrical support 44 on the seat 45 distal the channel member 46.

A female element 30 comprises a passage member 31 having both ends open and a sleeve 32 slidably put on both the passage member 31 and the valve member 40 due to the provision of a torsion spring 33 in a space defined by the sleeve 32, the valve member 40, and the passage member 31. The passage member 31 is threadedly secured to the valve member 40 and comprises four equally spaced openings 311 and a passage 312 with some parts of the valve member 40 disposed therein. The openings 311 shown in FIG. 3 are implemented as a first preferred embodiment. The opening 311 is substantially rectangular and has uneven inner wall. Two opposite inner stop members 313 are formed at both sides of each opening 311 respectively. The stop members 313 are proximate to the passage 312. Four fastening members 34 are disposed in the openings 311 respectively due to the provision of the stop members 313. The fastening member 34 is implemented as a first configuration and comprises an intermediate barbell section 341, a first projection 342 at one end, and a second projection 343 at the other end.

The fastening member 34 is partially disposed in the opening 311 before the coupling member 22 of the male element 20 is inserted into the passage 312 (see FIGS. 5 and 7). As shown in FIG. 5, the channel member 46 and other components of the valve member 40 above the channel member 46 are prevented from moving upward to leave the passage 312 due to the blocking engagement of the sealing ring 42 with a portion of the seat 45.

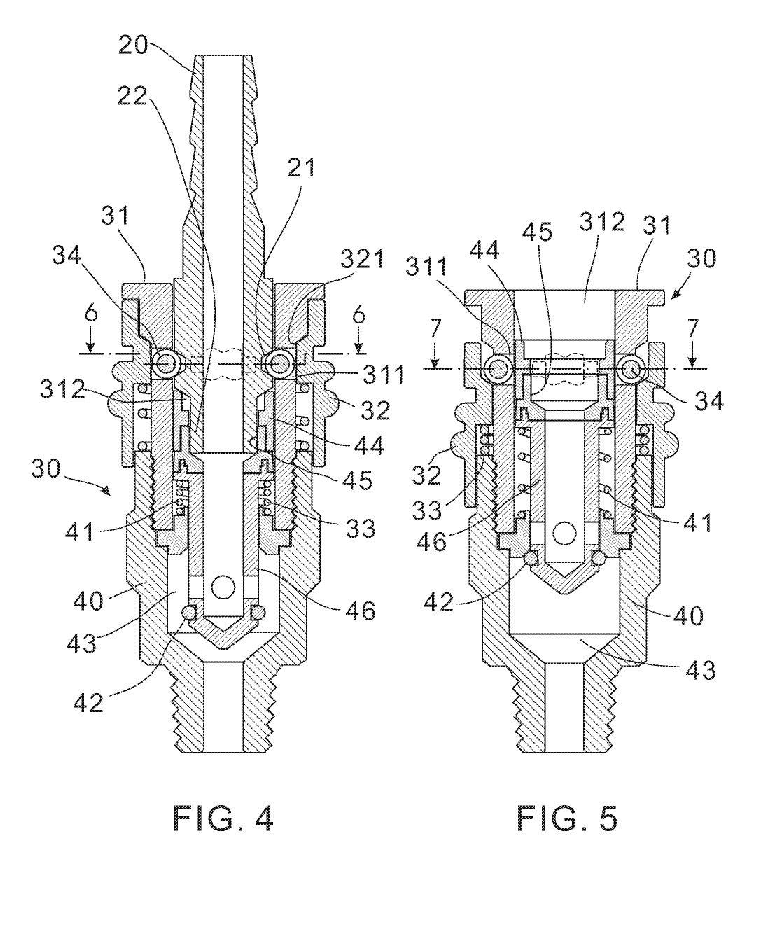

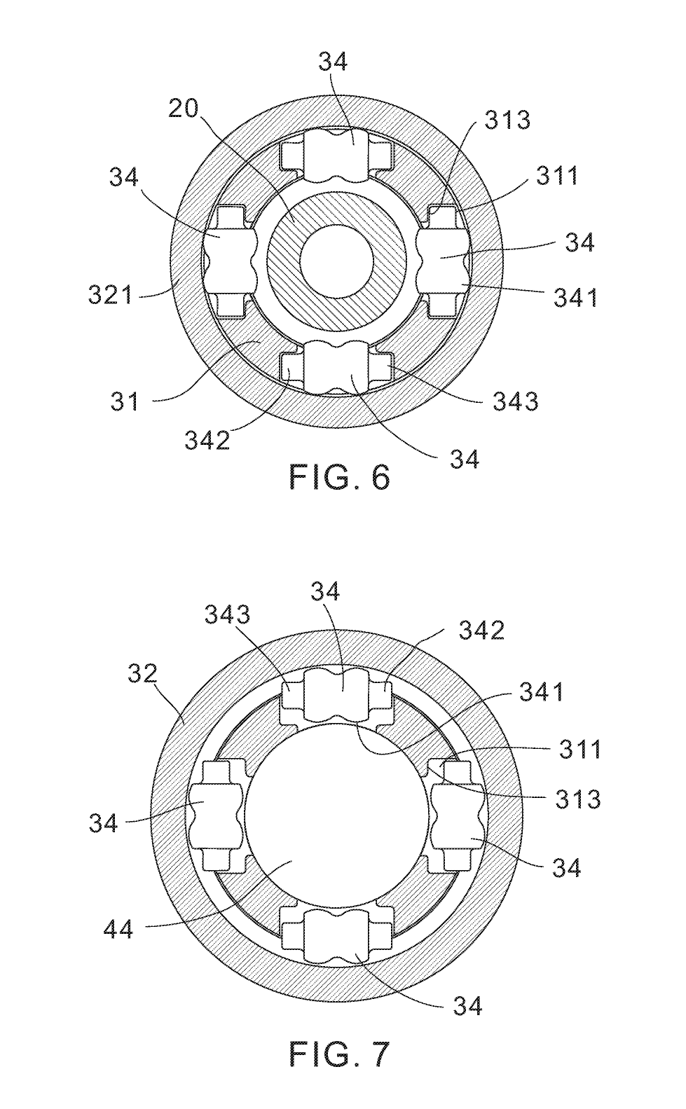

A person may insert the coupling member 22 into the passage 312 to push down the support 44 until the fastening member 34 partially enters the groove 21 to bear against the opposite inner stop members 313 due to the upward pushing force of the energized spring 33 (see FIGS. 4 and 6). Also, in FIG. 4, the spring 33 is expanded and the spring 41 is compressed as a result of the downward movement of the support 44, the seat 45 and the channel member 46. Fluid thus may flow from the male element 20 to the passageway 43 via the channel member 46.

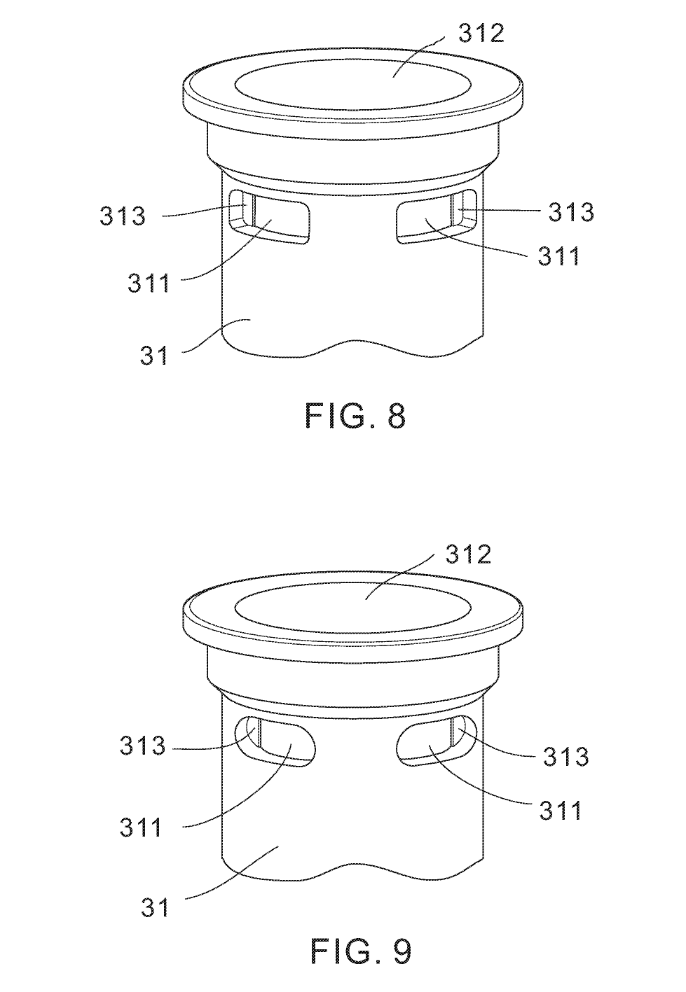

Referring to FIGS. 8 to 13, the quick coupling incorporates second and third preferred embodiments of the openings 311 and a second configuration of the fastening member 34 are shown.

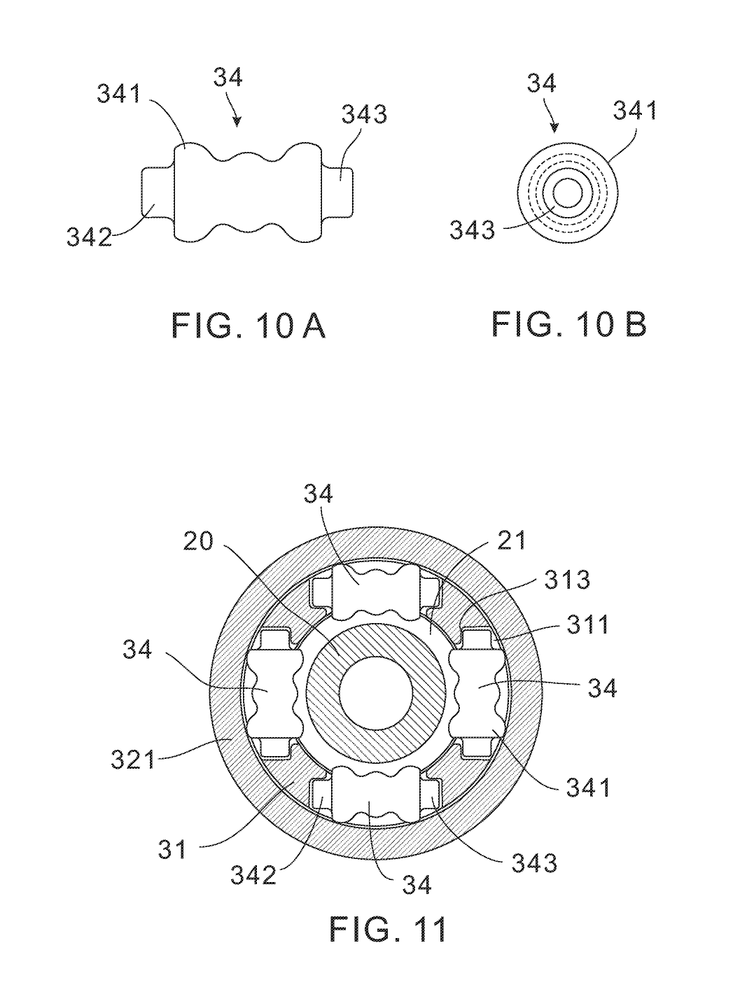

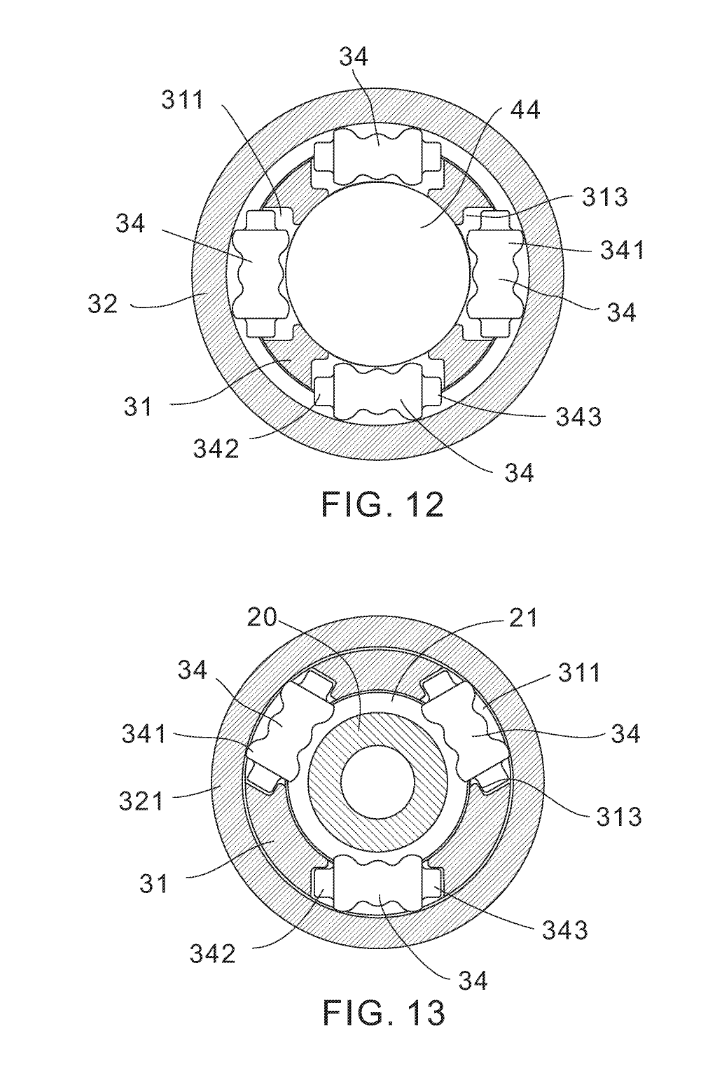

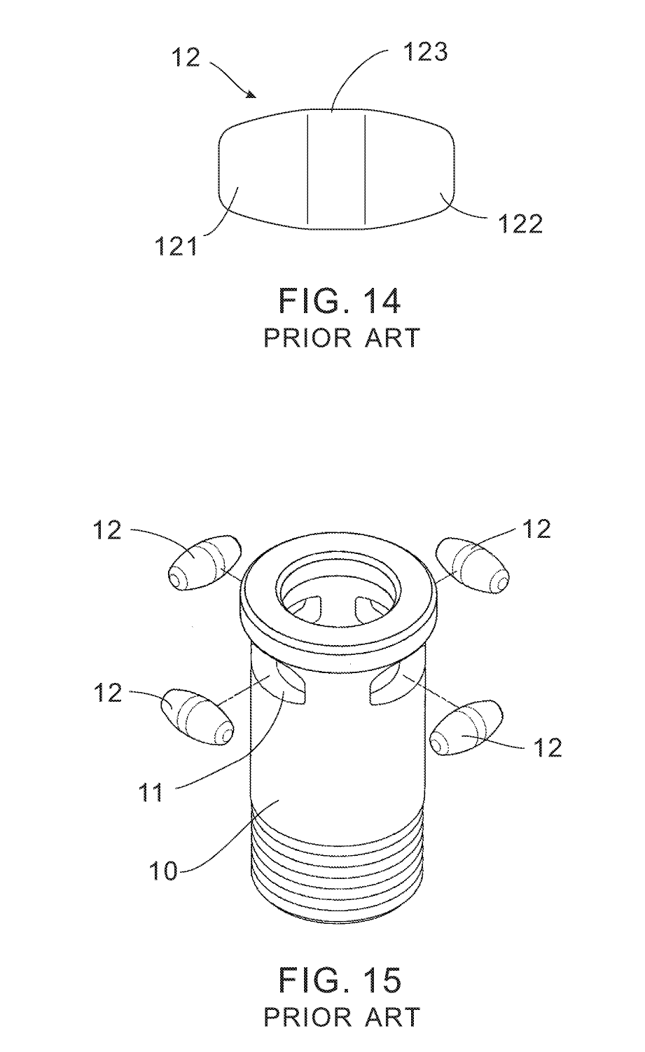

The opening 311 of the second preferred embodiment is shown in FIG. 8 and is shaped as a rectangle. The opening 311 of the third preferred embodiment is shown in FIG. 9 and is shaped as a rectangle and has an even inner wall. Further, the number of the openings 311 of the third preferred embodiment is three. The second configuration of the fastening member 34 has a wavy intermediate barbell section 341 (see FIGS. 10A and 10B). Four fastening members 34 are adapted to dispose in the openings 311 respectively (see FIG. 12). Three fastening members 34 are adapted to dispose in the openings 311 of the third preferred embodiment respectively (see FIG. 13).

While the invention has been described in terms of preferred embodiments, those skilled in the art will recognize that the invention can be practiced with modifications within the spirit and scope of the appended claims.

1. A quick coupling comprising:
a hollow male element having both ends open, the male element comprising a coupling member at one end and an annular groove adjacent to the coupling member;
a valve member comprising a passageway, a spring activated channel member being not in communication with the passageway before the male element and the valve member are joined; and
a female element comprising a passage member releasably secured to the valve member with the channel member partially disposed therein, the passage member including a plurality of equally spaced openings, a plurality sets of two opposite inner stop members wherein the opposite inner stop members of each set are formed at both sides of each opening respectively, and a plurality of fastening members moveably disposed in the openings respectively; and a spring activated sleeve slidably put on both the passage member and the valve member;
wherein the openings are rectangular and have an uneven inner wall;
wherein each of the fastening members have a barbell portion, a first projection at one end, and a second projection at an other end;
wherein the fastening members are partially disposed in the opening before the male element and the valve member are joined; and
wherein the fastening members partially enter the groove to bear against the opposite inner stop members and a communication is established from the male element to the passageway via the channel member after inserting the coupling member into the passage member to join the male element and the valve member in a locked position.
